(19) United States
(12) Patent Application Publication
(10) Pub. No.: US 2017/0114265 A1
(43) Pub. Date: Apr. 27, 2017

(54) WATER-BASED DRILLING FLUID FOR REDUCING BITUMEN ACCRETION

(71) Applicant: Secure Energy (Drilling Services) Inc., Calgary (CA)

(72) Inventor: Kuangbiao Ma, Calgary (CA)

(21) Appl. No.: 15/299,733

(22) Filed: Oct. 21, 2016

Related U.S. Application Data
(60) Provisional application No. 62/245,103, filed on Oct. 22, 2015.

(51) Int. Cl. C09K 8/035; C09K 8/22; C09K 8/524; C09K 8/04

(52) U.S. Cl. CPC C09K 8/035; C09K 8/04; C09K 8/22; C09K 8/524

(57) ABSTRACT

A drilling fluid for reducing bitumen accretion to wellbore drilling components is provided. The drilling fluid includes an anti-accretion additive including a soluble polyamino acid. In various embodiments, the soluble polyamino acid is an alkali metal salt of a polyamino acid, an example being sodium salt of polyaspartic acid. Further, the drilling fluid may be an aqueous-based drilling fluid. The soluble polyamino acid may alternatively or additionally include one or more of a homo-polymer of amino acids, a sequential co-polymer of amino acids, or a random co-polymer of amino acids. The drilling fluids may be used in a method for reducing bitumen accretion to wellbore drilling components.

### CROSS REFERENCE TO RELATED APPLICATIONS

This application claims the benefit of U.S. provisional application No. 62/245,103 filed Oct. 22, 2015 and is herein incorporated by reference in its entirety.

### FIELD OF THE INVENTION

The present invention relates to drilling fluids for reducing bitumen accretion to wellbore drilling components in oil drilling operations and more specifically to aqueous-based drilling fluids comprising an anti-accretion additive.

### BACKGROUND

The use of drilling fluid in drilling wellbores has allowed for drilling deeper, longer and more challenging wells. Various functions of drilling fluid include cooling and lubricating the drill bit, withdrawing drill cuttings from the wellbore, suspending the drill cuttings when the drilling string is brought in and out of the hole, providing buoyancy support of the drill string, preventing formation damage, corrosion prevention, stabilizing the rock formation to prevent drilling fluid from being absorbed by the formation, and controlling hydrostatic pressure to prevent formation fluids from entering the wellbore and increasing the risk of a blowout.

When drilling through bitumen-laden formations, for example tar sands in Athabasca, Canada or Utah, U.S., the cuttings generated from drilling operations will introduce significant amounts of bitumen into the drilling fluid. Bitumen is a generally tacky and viscous material, and has a tendency to adhere to surfaces. The accretion of bitumen to the drill string and other drilling components can cause high torque and drag while the accretion of bitumen to the screen of shale shakers may lead to shaker screen blinding resulting in inefficient cleaning of the drilling fluid. The buildup of bitumen on the drill bit can also block the drilling fluid channels and stop the circulation of drilling fluid. Other operational difficulties arise from the accretion of bitumen to the walls and/or casing of a wellbore which can result in an increase in wellbore pressure. Under severe circumstances, components of the wellbore may become plugged, resulting in a decrease or even a complete stoppage of oil production. Further, the removal of the drill string from the wellbore for cleaning or replacement increases rig times. These prolonged maintenance times increase the cost of oil production and should be minimized or avoided.

Anti-accretion additives are currently utilized in the industry. However, most additives are cost inhibitive. Also, some currently used additives are undesirable from an environmental point of view as the additives and/or decomposition products are toxic. Since the additives are used directly in the environment, it is desirable to avoid negatively affecting the environment in case of accidental spilling or unwanted seepage into the surrounding terrain.

An anti-accretion additive is desired that can reduce bitumen accretion to drilling components and that is soluble in aqueous drilling fluids.

### SUMMARY OF THE INVENTION

In one embodiment, the present invention provides for a drilling fluid for reducing bitumen accretion to wellbore drilling components, comprising an anti-accretion additive, the anti-accretion additive comprising a soluble polyamino acid.

In a further embodiment of the drilling fluid, the soluble polyamino acid is an alkali metal salt of a polyamino acid.

In a further embodiment of the drilling fluid, the drilling fluid is an aqueous-based drilling fluid.

In a further embodiment of the drilling fluid, the soluble polyamino acid comprises one or more of a homo-polymer of amino acids, a sequential co-polymer of amino acids, or a random co-polymer of amino acids.

In a further embodiment of the drilling fluid, the soluble polyamino acid is sodium salt of polyaspartic acid.

In a further embodiment of the drilling fluid, the molecular weight of the soluble polyamino acid is from about 500 to about 50,000 Dalton.

In a further embodiment of the drilling fluid, the molecular weight of the soluble polyamino acid is from about 500 to about 25,000 Dalton.

In a further embodiment of the drilling fluid, the molecular weight of the soluble polyamino acid is from about 1,000 to about 5,000 Dalton.

In a further embodiment of the drilling fluid, the soluble polyamino acid is present in an amount of from about 0.05 to about 25% by weight.

In a further embodiment of the drilling fluid, the polyamino acid is present in an amount of from about 0.05 to about 10% by weight.

In a further embodiment of the drilling fluid, the polyamino acid is present in an amount of from about 0.2 to about 2.5% by weight.

In a further embodiment of the drilling fluid, the drilling fluid comprises additional additives.

In a further embodiment of the drilling fluid, the additives are weighting compounds, corrosion inhibitors, lost circulation materials, fluid-loss control materials, lubricants, flocculants, thinners, deflocculants, dispersants, surfactants, biocides, pH control materials, scale inhibitors, shale stabilizers, iron controllers, defoamers or combinations thereof.

In a further embodiment of the drilling fluid, the viscosifier additive is xanthan gum, calcium montmorillonite or combinations thereof.

In a further embodiment of the drilling fluid, the fluid-loss control material additive is poly anionic cellulose, carboxymethyl starch or combinations thereof.

In a further embodiment, the present invention provides for a drilling fluid for reducing bitumen accretion to wellbore drilling components, comprising an anti-accretion additive, wherein the anti-accretion additive comprises sodium salt of polyaspartic acid.

In a further embodiment of the drilling fluid, the ratio of water:additives:sodium salt of polyaspartic salt is about 100: 1-20:0.5-5 by weight.

In a further embodiment of the drilling fluid, the ratio of water:additives:sodium salt of polyaspartic acid is about 100:6:1.2 by weight.

In a further embodiment of the drilling fluid, the ratio of water:xanthan gum:poly anionic cellulose:carboxymethyl starch:sodium salt of polyaspartic acid is about 100:0.05-1:0.05-1:0.05-1:0.05-1 by weight.

In a further embodiment of the drilling fluid, the ratio of water:xanthan gum:poly anionic cellulose:modified starch:sodium salt of polyaspartic acid is about 100:0.1:0.4:0.5:0.4 by weight.

In another embodiment, the present invention provides for a method of reducing bitumen accretion to wellbore drilling components in a drilling operation comprising providing a drilling fluid, drilling the wellbore in at least a portion of the subterranean formation using the drilling fluid and circulating the drilling fluid through the wellbore as it is drilled.

In a further embodiment of the method, the method further comprises removing drill cuttings from the circulating drilling fluid.

### DETAILED DESCRIPTION

Described herein are embodiments of drilling fluids for reducing bitumen accretion to wellbore drilling components comprising an anti-accretion additive and uses thereof as well as methods for reducing bitumen accretion to wellbore drilling components. It will be appreciated that the drilling fluids, volumes, masses, concentrations, uses, methods and embodiments described herein are for illustrative purposes intended for those skilled in the art and are not meant to be limiting in any way. All references to embodiments or examples throughout the disclosure should be considered a reference to an illustrative and non-limiting embodiment or an illustrative and non-limiting example.

According to one embodiment, there is provided a drilling fluid for reducing bitumen accretion to wellbore drilling components comprising an anti-accretion additive, the anti-accretion additive comprising a soluble polyamino acid. In another embodiment, the polyamino acid is an alkali metal salt of a polyamino acid. Some examples of alkali metal salts include lithium, sodium and potassium salts.

In a further embodiment, the drilling fluid is an aqueous-based drilling fluid in which the anti-accretion additive is at least partially soluble.

In the context of the present disclosure, bitumen, also referred to as asphalt, tar or pitch, includes any petroleum product that is generally sticky, highly viscous, and/or is in a semi-solid form and has a tendency to stick to drilling components and/or metal components.

In the context of the present disclosure, drilling components encompass, but are not limited to, the drill string which includes the drill bit, bottom hole assembly (BHA), transition pipe (heavyweight drill pipe), drill pipe and associated components. The drilling components also encompass components that process or circulate the drilling fluid, for example but not limited to, the shale shaker and components thereof such as the screens, suction line, drilling fluid pump, discharge line, stand pipe, rotary hose, swivel and drive unit such as the kelly drive or top drive. For the purposes of this disclosure, the walls of the wellbore including the casing of the annulus are also parts of the drilling components.

It has been determined that alkali metal salts of polyamino acids act as anti-accretion additives to reduce bitumen stickiness on surfaces. Examples of soluble polyamino acids that may be effective when used as drilling additives include, but are not limited to, homo-polymers of amino acids, sequential co-polymers of amino acids, or random co-polymers of amino acids.

Examples of homo-polyamino acids that may be effective when used as anti-accretion additives include, but are not limited to, poly-d-lysine, poly-l-lysine, poly-d-histidine, poly-l-histidine, poly-d-ornithine, poly-l-ornithine, poly-d-arginine, poly-l-arginine, poly-d-glutamic acid, poly-l-glutamic acid, poly-d-aspartic acid, poly-l-aspartic acid, poly-d-asparagine, poly-l-asparagine, poly-d-glutamine, poly-l-glutamine. Sequential co-polymers include, but are not limited to, an ordered sequence of the above amino acids. Random co-polymers include, but are not limited to, an un-ordered sequence of the above amino acids.

In a further embodiment, the drilling fluid comprises the sodium salt of polyaspartic acid (PASP), shown in formula (I). The sodium salt of PASP is a biodegradable polymer that decomposes into non-toxic aspartic acid monomers. This type of decomposition is desirable from an environmental point of view. PASP may also be synthesized in an environmentally-friendly method. In addition, the sodium salt of PASP may provide effective scale and corrosion inhibition which is desirable in a drilling fluid.

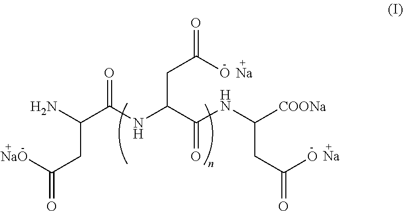

In a further embodiment, the drilling fluid comprises a soluble polyamino acid with a molecular weight of from about 500 to about 50 000 Dalton, for example, about 500, 1000, 5000, 10 000, 15 000, 20 000, 25 000, 30 000, 35 000, 40 000, 45 000 or 50 000 Dalton or various molecular weights therebetween. Further, the drilling fluid may comprise a range of amounts, for example, as defined by any two of the values listed above or any two amounts therebetween.

In another embodiment, the drilling fluid comprises a soluble polyamino acid with a molecular weight of from about 500 to about 25 000 Dalton, for example about 500, 1000, 5000, 10 000, 15 000, 20 000 or 25 000 Dalton or various molecular weights therebetween. Further, the drilling fluid may comprise a range of amounts, for example, as defined by any two of the values listed above or any two amounts therebetween.

In a further embodiment, the drilling fluid comprises a soluble polyamino acid with a molecular weight of from about 1000 to about 5000 Dalton, for example about 1000, 1500, 2000, 2500, 3000, 3500, 4000, 4500 or 5000 Dalton. Further, the drilling fluid may comprise a range of amounts, for example, as defined by any two of the values listed above or any two amounts therebetween.

In a further embodiment, the drilling fluid comprises a soluble polyamino acid in an amount of from about 0.05 to about 25% by weight, for example about 0.05, 0.1, 0.5, 1, 2, 5, 10, 15, 20 or 25% or weights therebetween.

Another embodiment of the drilling fluid comprises a soluble polyamino acid in an amount of from about 0.05 to about 10% by weight, for example about 0.05, 0.1, 0.5, 1, 2, 4, 6, 8 or 10% or weights therebetween.

An even further embodiment of the drilling fluid comprises a soluble polyamino acid in an amount of from about 0.2 to about 2.5% by weight, for example about 0.2, 0.5, 0.75, 1, 1.5, 2 or 2.5% or weights therebetween.

The drilling fluid may comprise additional drilling fluid additives, for example those commonly known in the art. Examples of some additional drilling fluid additives are weighting compounds that increase the drilling fluid density for drilling through heavily pressurized zones, for example, barite, hematitie, magnetite, iron oxide, lilmenite, dolomite and/or calcite; corrosion inhibitors to preserve the life of metallic components including for example ammonium bisulfite and/or phosphate esters; viscosifiers, commonly referred to as shale, to improve the ability of the drilling fluid to suspend cuttings among other functions, for example bentonite (magnesium-aluminum silicate), xanthan gum (examples include Secure Vis™, VerXan™ gum, XanVis® and OptiXan™), guar gum, sepiolite, attapulgite, calcium montmorillonite (examples include Rev Dust™) and/or various polymers and starches; lost circulation materials (LCM) that plug formation holes and fractures including for example granular materials (sized calcium carbonate, diatomaceous earth, perlite, vermiculite, amine-treated lignite, poly anionic cellulose), flaky materials (mica, pieces of plastic or cellophane), fibrous materials (shredded sugar cane, cotton fibers, wood fibers, corncobs, shredded rubber) and/or slurries (cement); fluid-loss control materials that reduce the amount of filtrate passing through a cake including carboxymethyl starch (CMS) (examples include Secure Star™), polyanionic cellulose (PAC) (examples include Secure PAC LVD™ and RD™) and/or carboxymethylcellulose (CMC); lubricants for example graphite, carboxymethoxy polymer, glass beads, gilsonite, cellulose, diesel oil, synthetic oil, vegetable oil, animal oil and/or mineral oil; flocculants for example hydrated lime, gypsum and/or synthetic polymers; thinners; deflocculants; dispersants; surfactants; biocides; pH control materials; scale inhibitors; shale stabilizers; iron controllers; defoamers, or combinations thereof.

In one example, the drilling fluid comprises the viscosifier additives: xanthan gum, montmorillonite, guar gum or combinations thereof and the fluid-loss control material additives: polyanionic cellulose, carboxymethyl starch or combinations thereof.

Another example of the drilling fluid comprises water:additives:sodium salt of polyaspartic acid in a ratio of about 100:1-20:0.5-5 by weight. A further example of the drilling fluid comprises water:additives:sodium salt of polyaspartic acid in a ratio of about 100:6:1.2 by weight.

In one embodiment, the drilling fluid comprises water:xanthan gum:poly anionic cellulose:modified starch:polyaspartic acid sodium salt in a ratio of about 100:0.05-1:0.05-1:0.05-1:0.05-1 by weight. In a further embodiment, the drilling fluid comprises water:xanthan gum:poly anionic cellulose:modified starch:sodium salt of polyaspartic acid in a ratio of about 100:0.1:0.4:0.5:0.4 by weight.

The present invention also provides for a method of reducing bitumen accretion to wellbore drilling components in a drilling operation. The method comprises combining an anti-accretion additive, such as those discussed herein, with the drilling fluid and injecting the drilling fluid during drilling of the wellbore in at least a portion of a subterranean hydrocarbon formation. The drilling fluid may be circulated through the wellbore as it is drilled. A further embodiment of the method involves separating drill cuttings from the circulating drilling fluid and re-using at least a portion of the filtered drilling fluid comprising the accretion additive.

It will be appreciated that the drilling fluids disclosed herein may comprise further anti-accretion additives, such as for example partially hydrolyzed polyacrylamide (PHPA) and/or phosphate ester.

### EXAMPLES

The following examples are presented to illustrate and demonstrate aspects of the invention and are not intended to be limiting.

### Example 1

Table 1 provides examples of drilling fluid compositions and properties for a general aqueous drilling fluid before and after the addition of an anti-accretion additive, namely sodium salt of polyaspartic acid, for sample drilling fluids 1 and 2, respectively. The following results were obtained from an OFITE® Model 900 Viscometer.

TABLE 1

Drilling Fluid

| | 1 | 2 |
|---|---|---|
| Water (g) | 300 | 300 |
| Secure Vis ™ (g) | 0.3 | 0.3 |
| Secure PAC R ™ (g) | 1.2 | 1.2 |
| Secure STAR ™ (g) | 1.5 | 1.5 |
| Rev dust ™ (g) | 15 | 15 |
| PASP (g) | 0 | 3.6 |

| | |
|---|---|
| | OFITE Dial |
| Shear Rate (RPM) | Reading (Pa) |

| | | |
|---|---|---|
| 600 | 72.9 | 71.7 |
| 300 | 50.7 | 49.9 |
| 200 | 41.3 | 40.4 |
| 100 | 27.9 | 27.3 |
| 6 | 5.5 | 5.3 |
| 3 | 3.4 | 3.3 |

Drilling Fluid Properties

| | | |
|---|---|---|
| Plastic viscosity (mPa · s) | 22.2 | 21.8 |
| Yield point (Pa) | 14.3 | 14.1 |
| 10 second gel (Pa) | 2.0 | 1.9 |
| 10 minute gel (Pa) | 2.5 | 2.5 |
| API (American Petroleum Institute) | 8.2 | 8.8 |
| fluid loss (mL) | | |

With reference to Table 1, plastic viscosity represents the viscosity of a drilling fluid when extrapolated to an infinite shear rate on the basis of the Bingham plastic model. A low plastic viscosity indicates that drilling can proceed at a fast rate because the drilling fluid exiting at the bit has low viscosity. The yield point is a parameter of the Bingham plastic model (the zero-shear-rate intercept in a Bingham plastic fluid plot) and is used to evaluate the ability of a drilling fluid to lift cuttings out of the annulus. The 10 second and 10 minute gel properties are the shear stress measurements at a low shear rate after the drilling fluid has sat for 10 seconds or 10 minutes. It is an indication of the gel strength of a drilling fluid. The API (American Petroleum Institute) fluid-loss test involves testing the static filtration behaviour of an aqueous-based drilling fluid and gives an indication of the effectiveness of the drilling fluid as a fluid loss control material.

Testing results in Table 1 indicate that the addition of PASP to the drilling fluid (drilling fluid 2) does not materially affect the drilling fluid properties. All parameters of the drilling fluids without or with PASP are nearly identical. It may therefore be concluded that the soluble polyamino acid anti-accretion additive, or alkali metal salts thereof, can be combined with the drilling fluid without negatively impacting the qualities and features of the drilling fluid. The polyamino acid anti-accretion additive, or alkali metal salts thereof, such as PASP, can also be added before or after other additives are added.

### Example 2

A series of laboratory tests were conducted using a test procedure developed to replicate the stickiness of bitumen on a surface. The results are presented in Table 2. In this example, four 300 mL samples of aqueous drilling fluids were tested. Sample 1 comprised the sodium salt of PASP, while samples 2 and 3 comprised other known anti-accretion additives, partially hydrolyzed polyacrylamide (PHPA) encapsulator and phosphate ester (purchased from Brine Add (now Engenium)) for comparison. PHPA is a long chain polymer and is therefore difficult to dissolve in the drilling fluid. Additionally, PHPA provides a constant high shear rate viscosity in which the viscosity of the drilling fluid is high at low shear rates (when drilling is stopped) as well as at high shear rates (during drilling). However, in certain circumstances, it is desirable to provide a drilling fluid wherein the viscosity of the drilling fluid is low at high shear rates and high at low shear rates such as is provided when using PASP or a sodium salt thereof as the anti-accretion additive. Sample 4 was used as a control and did not contain an anti-accretion additive. The samples were tested with a 100-gram bitumen core and a metal test rod placed in an OFITE® rolling cell to simulate a drilling component. Five rolling cells were then rolled for 16 hours at 35-38° C., and the metal test rod and the internal wall of the rolling cell were inspected for bitumen accretion. The mass of the metal rod was also determined both with accreted bitumen and after the accreted bitumen had been cleaned off. The results of these tests are set out in Table 2 below.

TABLE 2

| | Sample | | | |
|---|---|---|---|---|
| | 1 | 2 | 3 | 4 |
| Water (g) | 300 | 300 | 300 | 300 |
| Secure Vis ™ (g) | 0.3 | 0.3 | 0.3 | 0.3 |
| Secure PAC R ™ (g) | 1.2 | 1.2 | 1.2 | 1.2 |
| Secure STAR ™ (g) | 1.5 | 1.5 | 1.5 | 1.5 |
| Sodium salt of PASP (g) | 1.2 | 0 | 0 | 0 |
| PHPA Encapsulator (g) | 0 | 1.5 | 0 | 0 |
| Phosphate ester (mL) | 0 | 0 | 1.5 | 0 |
| Mass of accreted bitumen (g) | 0 | 0 | 0 | 51.6 |
| Observations | No bitumen | No bitumen | No bitumen on | Bitumen sticking |
| | on metal test | on metal | metal test rod, | to metal rod, wall |
| | rod, roller | test rod, | roller cell and | of roller cell, and |
| | cell and lid | roller cell | lid | lid severely |
| | | and lid | | |

TABLE 2 illustrates a dramatic decrease in the amount of bitumen accretion onto the metal rod when the drilling fluid contained the sodium salt of PASP (Sample 1), as compared to the case where the drilling fluid did not contain an anti-accretion additive (Sample 4) with all other aspects of the drilling fluid composition being the same in both cases. It can therefore be concluded that the anti-accretion additives, such as those described herein, when added to an aqueous based drilling fluid can provide at least some anti-accretion action or benefit to the wellbore drilling components in contact with the drilling fluid.

It will be appreciated that modifications, amendments and/or alterations to the compositions and methods described herein may be carried out and are intended to be within the scope and spirit of the invention.

We claim:

1. A drilling fluid for reducing bitumen accretion to wellbore drilling components, comprising an anti-accretion additive, the anti-accretion additive comprising a soluble polyamino acid.

2. The drilling fluid of claim 1, wherein the soluble polyamino acid is an alkali metal salt of a polyamino acid.

3. The drilling fluid of claim 1, wherein the drilling fluid is an aqueous-based drilling fluid.

4. The drilling fluid of claim 1, wherein the soluble polyamino acid comprises one or more of a homo-polymer of amino acids, a sequential co-polymer of amino acids, or a random co-polymer of amino acids.

5. The drilling fluid of claim 1, wherein the soluble polyamino acid is sodium salt of polyaspartic acid.

6. The drilling fluid of claim 1, wherein the molecular weight of the soluble polyamino acid is from about 500 to about 50,000 Dalton.

7. The drilling fluid of claim 6, wherein the molecular weight of the soluble polyamino acid is from about 500 to about 25,000 Dalton.

8. The drilling fluid of claim 6, wherein the molecular weight of the soluble polyamino acid is from about 1,000 to about 5,000 Dalton.

9. The drilling fluid of claim 1, wherein the soluble polyamino is present in an amount of from about 0.05 to about 25% by weight.

10. The drilling fluid of claim 9, wherein the polyamino acid is present in an amount of from about 0.05 to about 10% by weight.

11. The drilling fluid of claim 9, wherein the polyamino acid is present in an amount of from about 0.2 to about 2.5% by weight.

12. The drilling fluid of claim 1, wherein the drilling fluid comprises additional additives.

13. The drilling fluid of claim 12, wherein the additives are weighting compounds, corrosion inhibitors, lost circulation materials, fluid-loss control materials, lubricants, flocculants, thinners, deflocculants, dispersants, surfactants, biocides, pH control materials, scale inhibitors, shale stabilizers, iron controllers, defoamers or combinations thereof.

14. The drilling fluid of claim 13, wherein the viscosifier additive is xanthan gum, calcium montmorillonite or combinations thereof.

15. The drilling fluid of claim 13, wherein the fluid-loss control material additive is poly anionic cellulose, carboxymethyl starch or combinations thereof.

16. A drilling fluid for reducing bitumen accretion to wellbore drilling components, comprising an anti-accretion additive, wherein the anti-accretion additive comprises sodium salt of polyaspartic acid.

17. The drilling fluid of claim 1, wherein the ratio of water:additives:sodium salt of polyaspartic acid is about 100: 1-20:0.5-5 by weight.

18. The drilling fluid of claim 1, wherein the ratio of water:additives:sodium salt of polyaspartic acid is about 100:6:1.2 by weight.

19. The drilling fluid of claim 16, wherein the ratio of water:xanthan gum:poly anionic cellulose:carboxymethyl starch:sodium salt of polyaspartic acid is about 100:0.05-1:0.05-1:0.05-1:0.05-1 by weight.

20. The drilling fluid of claim 17, wherein the ratio of water:xanthan gum:poly anionic cellulose:modified starch:sodium salt of polyaspartic acid is about 100:0.1:0.4:0.5:0.4 by weight.
